(19) United States
(12) Patent Application Publication
(10) Pub. No.: US 2012/0208575 A1
(43) Pub. Date: Aug. 16, 2012

(54) METHOD AND DEVICE FOR MESSAGE HANDLING

(76) Inventor: Jeffrey Wilson, Hampshire (GB)

(21) Appl. No.: 13/503,402

(22) PCT Filed: Oct. 22, 2010
(86) PCT No.: PCT/GB10/01969

§ 371 Date: Apr. 23, 2012

(30) Foreign Application Priority Data
Oct. 23, 2009 (GB) 0918675.0
May 6, 2010 (GB) 1007616.4

(51) Int. Cl. H04W 4/14

(52) U.S. Cl. 455/466

(57) ABSTRACT

A method for providing a service function in a telecommunications network is described. The method comprises receiving a message (32) addressed to an addressee subscriber (20) of the telecommunications network. The received message may be an MMS message or an SMS message in a mobile terminated (MT) format and/or may come from a subscriber of a different network. The method further comprises determining whether the body of the received message conforms to a predefined criterion, and, if so, selectively providing the service function. In one example the predefined criterion is a specific syntax for the body of the received message. The processing function may comprise sending a response message to the sender of the received message providing information previously specified by the addressee subscriber. Thus a sending user can obtain the information previously specified by the addressee subscriber by simply sending him a message conforming to the predefined criterion. The received message might not be forwarded on to the addressee subscriber so that he is not disturbed when messages are received to request the relevant information.

### BACKGROUND OF THE INVENTION

The invention relates to apparatus and methods for use with mobile telecommunications networks, such as a mobile telephone system. The invention is particularly concerned with the provision of additional service functions in such systems in association with received messages.

Mobile telecommunications systems such as the well known GSM (Global System for Mobile communications) system include a scheme for the transmission and reception of short text messages between users. In GSM and IS-41/ANSI-41 systems, this functionality is provided by the Short Message Service (SMS). Such networks also allow for the sending of more content rich messages, such as Multimedia Messaging Services (MMS) messages. Functionally MMS messages may be considered by users as an advanced form of SMS messaging, although in practice there are differences in how SMS and MMS messages are handled in telecommunications networks. The handling of both types of message is well defined and widely understood. For the purposes of explanation the present invention is primarily described herein in the context of GSM systems. However, it will be appreciated that embodiments of the invention may equally be implemented in other telecommunication systems which support the sending of text messages.

As is well known and defined in the relevant standards, SMS messaging relies on two services: Mobile Originated (MO) between an originating terminal (e.g., a telephone handset) and a Short Message Service Centre (SMSC), or equivalent functional entity (such as an SMS Router of the type available from Telsis Limited), in the message originator's home network, and Mobile Terminated (MT) between the SMSC (or equivalent functional entity) and a recipient's terminal (e.g., a telephone handset). MO and MT services comprise different message formats and addressing methods, such that the MO and MT paths of a message transmission are functionally distinct.

In some networks, typically those in North America, SMS messages are exchanged between different telecommunications networks using a centralised aggregator that is connected to host interfaces of each network's SMSCs. Messages to the aggregator from SMSCs in the sending network may be designated as Host Terminated (HT) format, and messages received in the recipient's network from the aggregator may be designated as Host Originated (HO) format.

In addition to being simply able to send and receive text messages, there are other services/processing functions which may be provided by networks in association with text messages.

For example, processing functions can be carried out in an originating network (i.e. the home network of a message sender) which are dependent upon characteristics of the message sent by the sender/originator. For example, SMS can support the provision of delivery receipts or message status reports, which provide an indication of the delivery status of a message. These can be requested by the originator of a short message e.g., by using a handset setting that causes a particular signalling indication to be carried with an MO message. Provision of these types of feature and the particular methods of activation by message originators is network operator dependent.

It is generally not possible with “classic” network architectures to implement additional SMS services/functions for the B-Party's network. (As is conventional, the terms A-Party and B-Party are used herein to respectively distinguish the sending and addressee parties to a text message.) This is because the GSM architecture causes MT messages to be delivered directly from an SMSC in the A-Party's network to a Visited Mobile Switching Centre (VMSC) where the B-Party is located. Thus there is no central control point through which all MT messages pass in the B-Party's network where an additional service function could be applied. In some cases (e.g., when the B-party is roaming on a network other than his home network), the MT message might never pass through the B-Party home network at all.

A technique that helps to address this issue is the so-called SMS Home Routing technique, e.g., as described in EP 1 474 934 [1]. SMS Home Routing is a technique which allows for all MT messages to be routed via a particular service apparatus in a recipient's home network (or one of a bank of related service apparatus) and has therefore made possible the provision of B-Party SMS services in the receiving network. For example, EP 1 408 705 [2] describes a technique for allowing text message recipients to control aspects of message delivery and processing, such as mobile terminated message services and routing to email. EP 1 815 697 [3] describes mobile terminated service applications such as an SMS Divert service provided for a message addressee.

It is known in email systems, and to some extent in voice and short message systems, that a status text message, often called an ‘out-of-office’ or “auto-reply” message, can be returned by an intended recipient's communication system to the originator of a communication (such as a voice, email or SMS communication), e.g., when the communication is unsuccessful. When this service is provided, the content of the status message may have been previously configured by the intended recipient of the failed communication, or may be automatically provided by the network.

An example of the limitations of existing status message techniques in communication networks is evident from the following example situation. Consider a coach of a sports team who needs to deal with perhaps twenty or thirty different people to confirm arrangements prior to every practice session or match. If the coach wants to avoid repeatedly explaining the necessary information in person, he has a number of options using known techniques. For example, the coach can newly record an appropriate out-going voice mail announcement providing the relevant information. The coach can then reject the twenty or thirty calls from the people who need the information so the callers hear the announcement. Similarly, the coach could configure a reply text message with the relevant information in his handset and reject the calls with this preset text message. However, in these cases, the coach is disturbed by each enquiry, he may potentially reject calls that are unconnected with the sports event, and callers unrelated to the sports event will receive an irrelevant message if his phone is busy or unreachable.

There is therefore a need for methods and apparatus which allow for the selective provision of service functions on behalf of addressees/recipients of SMS and/or MMS messages in telecommunications networks.

### SUMMARY OF THE INVENTION

According to an aspect of the invention there is provided a method for providing a service function in a telecommunications network, the method comprising: receiving in the telecommunications network a message addressed to an addressee subscriber of the telecommunications network, wherein the message is a SMS message in a mobile terminated (MT) format or a MMS message; determining whether the body of the received message (e.g. the textual content of the message specified by the sender) conforms to a predefined criterion; and selectively providing the service function dependent upon whether or not the body of the received message conforms to the predefined criterion.

According to another aspect of the invention there is provided a method for providing a service function in a telecommunications network, the method comprising: receiving in the telecommunications network a message addressed to an addressee subscriber of the telecommunications network originating from a subscriber of a different telecommunications network, wherein the message is a SMS message or a MMS message; determining whether the body of the message conforms to a predefined criterion; and selectively providing the service function dependent upon whether or not the body of the message conforms to the predefined criterion.

Thus embodiments of the invention provide a means for allowing a service function to be selectively carried out by a B-Party's network dependent upon a characteristic of a message, e.g. an SMS or MMS message, originated by an A-Party and addressed to the B-Party.

The service function may, for example, comprise sending a response message to the originator of the received message. The response message may include information content specified by the addressee subscriber for use in conjunction with the service function, e.g., information content which the addressee subscriber wishes to disseminate, such as a personal status message. The information content may include information specified by the addressee subscriber in a configuration message previously sent to the telecommunications network. In some examples the information content may comprise a number of components (e.g. audio, text, video and/or picture components), and wherein different ones of the components are specified by the addressee subscriber in different configuration messages.

Alternatively, or in addition, the response message may include information content automatically generated by the network.

Such a scheme might be employed, for example, to provide for the returning on demand of an indication of the personal status of a B-Party, in a personal status message, to an originator who sends a personal status query message to the B-Party.

Providing the service function may further comprise inhibiting forwarding of the received message to the addressee subscriber. This allows senders of messages conforming to the predefined criterion to obtain a response message, e.g., relevant to the addressee subscriber's current status and/or containing information the addressee subscriber wishes to make available, without the addressee subscriber being disturbed.

In accordance with embodiments of the invention the body of the message may be considered to conform to the predefined criterion if the body of the message corresponds to a predefined syntax, e.g., if it contains a pre-defined character/character string.

In some examples the provision of the service function may also depend on the identity of the originator of the received message, e.g., based on whitelisting or blacklisting schemes.

Methods in accordance with embodiments of the invention may further comprise selectively providing the service function dependent upon at least one further criterion being met, e.g., based on the time of day or location of addressee.

According to another aspect of the invention there is provided a system for providing a service function in a telecommunications network, the system comprising: a message receiving unit operable to receive in the telecommunications network a message addressed to an addressee subscriber of the telecommunications network, wherein the message is a SMS message in a mobile terminated (MT) format or a MMS message; a determination unit operable to determine whether the body of the received message conforms to a predefined criterion; and a function providing unit operable to selectively provide the service function dependent upon whether or not the body of the received message conforms to the predefined criterion.

According to another aspect of the invention there is provided a system for providing a service function in a telecommunications network, the system comprising: a message receiving unit operable to receive in the telecommunications network a message addressed to an addressee subscriber of the telecommunications network and originating from a subscriber of a different telecommunications network, wherein the message is a SMS message or a MMS message; a determination unit operable to determine whether the body of the received message conforms to a predefined criterion; and a function providing unit operable to selectively provide the service function dependent upon whether or not the body of the received message conforms to the predefined criterion.

Thus according to an aspect of the invention there is provided an apparatus comprising means for receiving a mobile terminated short message, means for determining whether the body of the received message meets a certain criterion, and means for selectively carrying out a further function dependent upon the criterion being met.

According to another aspect of the invention there is provided an apparatus comprising means for receiving a short message from an A-Party on another network, means for determining whether the body of the received message meets a certain criterion, and means for selectively carrying out a further function dependent upon the criterion being met.

According to some embodiments of the invention the behaviour of the function may be modified by a whitelist or blacklist of originators configurable in advance by the B-Party (addressee subscriber).

### BRIEF DESCRIPTION OF THE DRAWINGS

For a better understanding of the invention and to show how the same may be carried into effect reference is now made by way of example to the accompanying drawings in which:

FIG. 1 schematically shows a system for selectively providing a service function for a subscriber of a telecommunication network according to an embodiment of the invention;

FIG. 2 schematically shows a system according to another embodiment of the invention; and

FIG. 3 schematically shows a system according to yet another embodiment of the invention.

### DETAILED DESCRIPTION

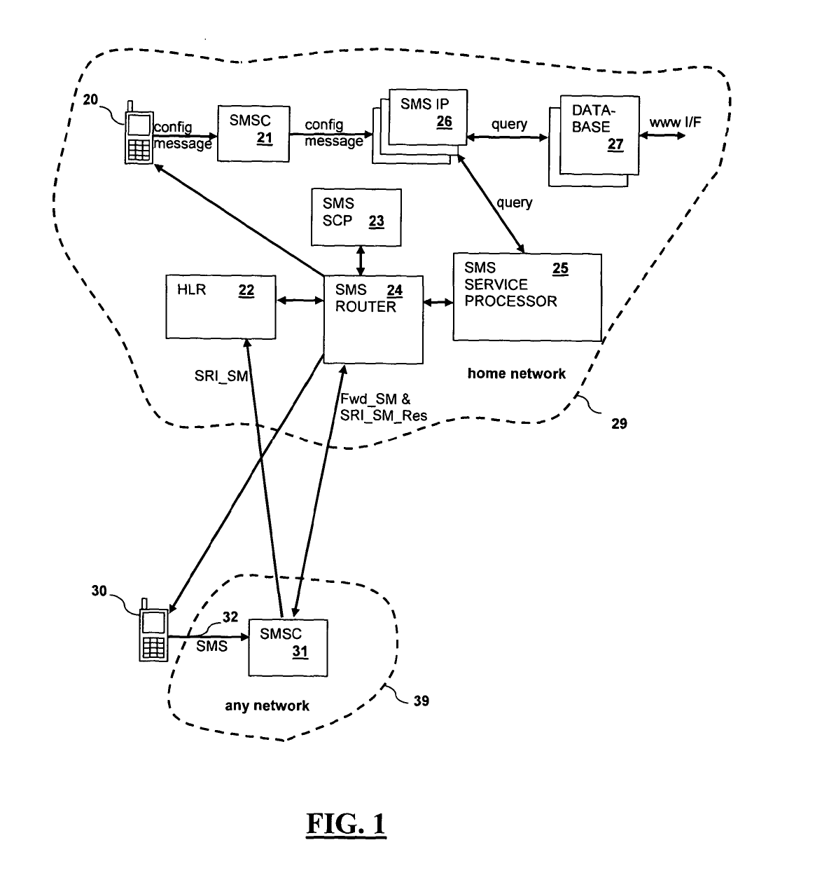

FIG. 1 schematically shows a system for selectively providing a service function for a service subscriber 20 of a telecommunication network 29 according to an embodiment of the invention. Embodiments of the invention can be used to implement various different service functions, but for the purpose of explanation FIG. 1 is described in the context of a specific example service function. This function is the automated sending of a status message, e.g., a message indicating the personal status of the subscriber 20, in response to text-message based requests from a sender 30 for this information.

The network 29 providing the service will be referred to here as the “home network” for the service subscriber 20 on whose behalf the service function is provided. The service subscriber 20 may also be referred to as the B-party or addressee subscriber since in accordance with some embodiments of the invention the service function is provided on behalf of the service subscriber 20 in response a message (e.g. an SMS or an MMS message) being addressed to this subscriber.

The service in this example is optional in that some subscribers of the network 29 may benefit from the service while others may not. Telephone handset 20 in FIG. 1 schematically represents a user who is a subscriber of the service function (e.g., because he has chosen to pay extra for the service). In other examples, all users of the network 29 may be provided with the relevant functionality, e.g., because it is a “free” service provided to all users by the network operator.

The sender 30 of the request for the status information is schematically represented in FIG. 1 as being a subscriber of network 39. This network may be referred to here as “any network” to reflect the fact the sender 30 and service subscriber 20 may subscribe to the same or different networks (i.e. the service subscriber's network 29 and the request sender's network 39 may the same or different networks).

The home network 29 of user 20 schematically shown in FIG. 1 comprises various elements, as now described.

The network 29 includes a Short Message Service Centre (SMSC) 21. This represents the conventional Mobile Originated (MO) format text message handling apparatus of the home network. Various conventional aspects of the SMSC 21, e.g., its connection to a home location register (HLR) in the home network, are not shown in FIG. 1 for simplicity. Also shown in FIG. 1 is a SMS intelligent peripheral (IP) 26. This is schematically represented a bank of parallel apparatus, e.g. for redundancy or load sharing, but a single equipment could equally be used. The SMS IP 26 provides inter alia the function of what might be termed a configuration message processor, as described further below. The SMS IP 26 is arranged to receive and process certain text messages (referred to here as configuration messages) from the SMSC 21. The SMS IP 26 is communicatively coupled to a database 27. The database stores various operational data relating to the service function, e.g., a listing of users having the service activated, and data needed to provide the service, e.g., in this example a record of the status message to be provided. In this example, the database 27 may also be accessed via an internet connection/interface (www I/F).

The network also includes a home location register (HLR) 22, SMS router 24 and associated SMS service control point (SCP) 23. These are arranged to provide a “Home Routing” functionality for text messages sent to users of the home network, e.g., service subscriber 20. Thus the HLR 22 is patched to pass routing information requests received from SMSC 31 (representing an SMSC in the message sender's network 39) to SMS router 24 in the manner described in EP 1 474 934 [1], thus causing mobile terminated messages addressed to the service subscriber 20 to be delivered to the SMS Router 24 of network 29. The service subscriber 20 in FIG. 1 is schematically shown connected directly to his home network (i.e. shown inside the dashed line representing the network 29). However, the service subscriber 20 could equally be roaming on another network, e.g., in another country. That is to say the same principles apply regardless of the service subscriber's location.

The SMS Router 24 is coupled to an SMS service processor 25. The service processor is responsible for managing the application of the service function as described further below.

There are two main aspects/modes of operation associated with providing the service function of the embodiment of the invention shown in FIG. 1.

In a first mode, namely a configuration mode, the service subscriber 20 of the home network 29 is able to configure/provision the service function (i.e. to activate/deactivate the service and specify the contents of his personal status message) by sending a conventional SMS message (“config message” in FIG. 1) to a specified destination address. The SMS message contains appropriate configuration information, and may thus be referred to as a configuration message.

In a second mode, namely a service provision mode, text messages addressed to the subscribing service subscriber 20 are received in the network 29 and are processed to selectively provide the service function as appropriate.

Thus the service subscriber 20 may send a configuration text message via the Mobile Originated text handling apparatus of his home network, represented by SMSC 21 in FIG. 1, to a pre-specified address for sending configuration messages to the service. Typically configuration messages would be addressed to a short code or service number, indicating to the SMSC 21 that the message is a configuration message and is to be forwarded to the SMS IP 26. The SMS IP 26 interprets the content of the text message and makes appropriate changes to the database 27. For example, the configuration message sent by the service subscriber 20 might contain text specifying the relevant status message the service subscriber wishes to be sent to in response to requests for the information. The SMS IP 26 thus updates the database 27 to reflect the new configuration state. This database update may be performed in accordance with known database management techniques. (The SMS IP 26 may identify that the configuration message relates to the specific service subscriber 20 from the field in the message received from the SMSC 21 representing the origination address of the service subscriber 20.)

Thus a configuration change requested by a service subscriber in an SMS message sent to a destination address associated with the SMS IP 26 (and routed to the SMS IP 26 via the SMSC 21 in accordance with conventional SMS routing techniques) results in a change to data stored in the attached database 27. A new record may be created in the database 27, or an existing data record may be modified. The configuration change in the data base may in some examples be confirmed to the sender when complete, e.g., using a separate text message sent from the SMS IP 26 to the service subscriber 20.

It will be appreciated that many of the various service functions which may be provided by embodiments of the invention will not need any user configuration (e.g., the service function may not be personalised). Such embodiments will not include the configuration aspects of the example of FIG. 1.

Selective provision of the service function will now be described.

When an originating subscriber 30 of any network 39 sends a text message 32 via his SMSC 31 addressed to the service subscriber 20, the SMSC 31 queries the HLR 22 of the home network 29 with an SRI_SM (Send Routing Information for Short Message) request message in the usual way. SMS Home Routing takes place which forwards the SRI_SM query to the SMS Router 24, which replies to the SMSC 31 on behalf of the HLR 22, giving its own address as the delivery address for the text message 32. This causes the sender's SMSC 31 to deliver the message 32 to the SMS Router 24. The SMS Router then queries the SMS Service Control Point (SMS SCP) 23 to determine the services subscribed to by service subscriber 20, and finds that this user subscribes to the relevant service function. The SMS Router 24 thus passes the text message 32 to the SMS Service Processor 25 to check the content of the message 32 to see whether the message meets a predefined criterion (discussed further below). If not, the message is delivered normally via the SMS Router 24 to the service subscriber 20. If the criterion is met by the content of the body of the text message 32, then the SMS Service Processor 25 queries the database 27, in this case via the SMS IP 26, to determine the function to be executed. The SMS Service Processor 25 then executes the desired function.

Having described features of embodiments of the invention in general terms, the present invention is now described in the context of the specific example service function identified above. This example is directed to addressing a limitation of known schemes by allowing a service subscriber's home network 29 to respond on behalf of the service subscriber (B-Party) to a status enquiry from an A-Party addressed to the B-Party. As discussed above, embodiments of the invention can also allow the content of the personal status message to be configurable at least in part by the B-Party 20 and/or automatically by his network 29. In an embodiment, an A-Party 30 who is a subscriber of any network 39 may query the personal status of the B-Party 20 who is a subscriber of the home network 29.

The content of the personal status message may be configured in a variety of ways. E.g., and as described above, in some embodiments the B-Party is able to pre-configure the literal text of his personal status message by sending to a service number a message with a predefined syntax and containing the desired personal status text. For example, the configuration syntax may be a single dot followed by the desired personal status text. Other syntaxes are of course possible. Similarly, the user may cancel the sending of personal status messages by sending a predefined configuration message. For example, in one embodiment the text ‘.’ followed by the text of the desired personal status message might be used to set up a personal status message to be sent in response to a status enquiry, and the text ‘.’ on its own sent as a configuration message might be used to cancel any configured personal status message. If no personal status is set, then a default status message may be sent in response to a status enquiry, for example “No status set”. In some embodiments the B-party may configure the provision of the service function via the Internet interface www I/F instead of, or in addition to, through the use of configuration text messages.

In some embodiments, part of the personal status message may be configured as described above, with the remainder provided by other means. In an embodiment, all or part of the personal status message content may be derived automatically when required, based for example on location information provided by the network, or whether the user is currently in a vehicle. All or part of the personal status message may be derived from another application, for example an Out-of-Office status message set up for responding to unsuccessful text, voice or video communications. In an embodiment, the personal status message may be generated as desired, using any combination of user-entered or automatically sourced text. In an embodiment, rules may be defined to allow personal status configuration to change dependent upon other factors such as for example time of day, or upon the originating address of the inquiring subscriber (e.g., a whitelist or blacklist indicating which originator subscribers receive personal status messages and which do not, or a table indicating which originating subscriber receives which personal status information). It would be possible for example for all inquiring subscribers to receive a manually configured text portion of the personal status, while whitelisted subscribers also receive an automatically added portion indicating current location. Many other permutations are possible.

Once configured, subsequent personal status enquiries from any allowed subscriber will result in a returned message containing text corresponding to the configured personal status. The user (service subscriber) can change the configuration at any time in order that the returned personal status messages can reflect his current personal status if so desired, or to cancel the personal status message as required.

As discussed above, configuration messages addressed to the service number may be routed to the SMS IP (Intelligent Peripheral) 26, e.g., using known routing or grooming techniques for MO messages. The SMS IP 26 uses the origination address of the configuration message to identify the user, and uses a database to identify the services subscribed to by this user. If the syntax of the message corresponds to the predefined syntax of a configuration message for a subscribed service, then the SMS IP updates configuration settings for that service and service subscriber stored in the database.

Two basic scenarios for selectively providing a service function in accordance with embodiments of the invention may be distinguished. The first scenario (as shown in FIG. 1) is based on the standard GSM architecture, where inter-network message transfer occurs over the Mobile Application Protocol (MAP). In this architecture, the SMSC of the originating (A-Party) network performs a lookup request addressed to the HLR of the B-Party's home network. The originating (A-Party) and destination (B-Party) network may be the same network or different networks. The MT message is then delivered to the address provided in the response to the HLR lookup request. SMS Home Routing modifies the address provided, allowing the message to be captured by an equipment in the B-Party's home network, as described above.

The second scenario, which is predominantly applicable to North American mobile networks, is where inter-network text message transfer is carried out via an aggregator that is typically connected to participating networks via SMPP over TCP/IP. In this scenario, messages sent to subscribers of other networks are first delivered from the A-Party's SMSC via the aggregator to an SMSC in the B-Party's home network. (The identity of the B-Party network can be determined from the prefix of the B-Party address.) The B-Party's SMSC then does an HLR lookup to determine the B-Party's location, and then the MT message is delivered. SMS Home Routing is not required in this scenario because all messages are already delivered via an equipment (the SMSC) in the B-Party's home network. Thus whereas in the first scenario SMS Home Routing ensures text messages sent to the service subscriber can be “captured” for processing when they arrive in the home network in MT format, in the second scenario messages from other networks can also be “captured” for processing when they are received in the B-Party network from an aggregator—i.e. when they are in a host originating (HO) format. Thus in general terms for both scenarios, the messages are “captured” when they are not in an MO format.

The personal status enquiry phase of the example service is now described in the context of the first scenario. In order for the service to be applicable to enquiry messages from a sender who is a subscriber of any network, the enquiry message is processed in its mobile terminated phase, since in the mobile originated phase the query messages are only available to the originating network. The mobile terminated messages addressed to the user of the home network are thus routed via an equipment in the home network using known SMS Home Routing techniques as described above.

Using SMS Home Routing, mobile terminated messages addressed to a user that is a subscriber to a network service that implements the present example embodiment are routed to the apparatus for selectively providing the service function in the home network. The apparatus may be dedicated to the example service, or may preferably provide a range of advanced services for mobile terminated messages addressed to the home network's subscribers. On receipt of a home routed message addressed to the user/service subscriber, the apparatus preferably first checks that the user is a subscriber to the service by querying an SMS SCP. This checks a database of subscribers and the associated MT message services to which they are subscribed. If the user is a subscriber to the service, the message is passed to an SMS Service Processor component of the apparatus which checks whether the message body meets a criterion, the meeting of which indicates a personal status enquiry by the originator. The term message body refers to part of a text message that carries the textual content of the message. In a preferred embodiment, the personal status enquiry criterion is a message content syntax comprising a single dot at the start of the message followed by no other characters; other criteria or syntaxes are of course possible.

If the predefined personal status enquiry syntax is detected in the message body, then the message is treated as a personal status enquiry, and is preferably not delivered to the addressed user. Instead, subject to any whitelisting or blacklisting of originators that may be in force, the apparatus generates a personal status message that is returned to the originator. The personal status message is generated according to the configuration settings for this user as described above. The personal status message preferably provides a textual indication of the personal status of the user. If the originator is blacklisted for personal status messages, or not on an active whitelist for personal status messages, then the personal status enquiry is silently discarded and no personal status message is returned.

In order to generate a personal status message, the SMS Service Processor sends a query to an SMS IP. The SMS IP accesses the attached database in which the user's configuration information is stored, and uses the configuration data to construct the personal status message. The SMS Service Processor would preferably be responsible for assembling the desired personal status message from user-configured and/or automatically generated content portions as required. The text of the complete personal status message is then formatted as a short message and transmitted to the originator via the SMS Router. Thus an A-Party can obtain the relevant information/status message simply by sending a text message conforming to the predefined criterion (e.g. containing a pre-agreed text string for the service) to the service subscribing addressee in the usual way.

The personal status enquiry phase of the invention is now described in the context of the second scenario. In order for the service to be applicable to enquiry messages from a subscriber of any network, enquiry messages from other networks are detected either amongst messages arriving over the host interface from the aggregator, normally over SMPP, or amongst MT messages prior to delivery (in line with the first scenario described above). These messages may be collectively referred to as Host Originated (HO) and Mobile Terminated (MT) messages, to distinguish them from Mobile Originated (MO) format messages that have arrived at the SMSC over MAP from the B-Party network's own subscribers. Messages from on net A-Party subscribers (i.e. where the A-Party and B-Party are subscribers of the same home network) can be detected amongst the MT messages prior to delivery.

Accordingly, the apparatus preferably checks either the HO messages or the MT messages in order to implement selective service function processing in accordance with embodiments of the invention. On processing an HO or an MT message addressed to the user, the apparatus preferably first checks that the user is a subscriber to the service. This checks a database of subscribers and the associated message services to which they are subscribed. If the user is a subscriber to the service according to the present invention, the apparatus checks whether the message meets a criterion, the meeting of which indicates a personal status enquiry by the originator. In a preferred embodiment, the personal status enquiry criterion is a message content syntax comprising a single dot at the start of the message followed by no other characters; other criteria or syntaxes are of course possible.

If the predefined personal status enquiry criterion is met by the message, then the message is treated as a personal status enquiry, and is preferably not delivered to the addressed user. Instead, subject to any whitelisting or blacklisting of originators that may be in force, the apparatus generates a personal status message that is returned to the originator. The personal status message is generated according to the configuration settings for this user as described above. The personal status message preferably provides a textual indication of the personal status of the user. If the originator is blacklisted for personal status messages, or not on an active whitelist for personal status messages, then the personal status enquiry is silently discarded and no personal status message is returned.

The described example allows a text message originator to check the personal status of a service subscriber by text message without disturbing them or initiating a dialogue, and provides the service subscriber with control over the enabling of this facility and its content. The scheme is very easy for the service subscriber to manage, because configuration changes can be effected with a single text message, or alternatively can be performed on the web. The scheme is also very easy for the originating subscriber to use, because the enquiry message is directed to the user's normal telephone number, and hence the facilities of the subscriber's handset such as the phone book can be used in the normal way to create the enquiry message.

A further example of the invention may be illustrated by the following example, where the coach of a sports team wishes to regularly disseminate information to members of his team, without either being disturbed by multiple incoming communications, having to make multiple outgoing communications, or giving out the same information multiple times. In accordance with embodiments of the present invention, the coach can set up a personal status message, which in this case could be text such as—

“Training on Saturday 21st is at the West Ground and starts at 2 pm.”

Then, each and every interested party can send a personal status enquiry to the coach's normal telephone number, and receive back the configured message. This fulfils the need for disseminating the information to multiple parties without disturbing the coach.

Furthermore, the disseminated information could relate to anything desired, and need not necessarily be a reflection of any personal status. The invention when used in this way can provide a publishing capability for a B-Party, who can configure any item of information desired for publication/dissemination, and hence allow any inquiring party to receive this information on demand by sending a status enquiry message to the B-Party's normal telephone number.

Benefits of a personal status service, which is just one example of an application of an embodiment of the present invention, include the following—
for social networking, where contacts can keep in touch with a user's personal status by text message when they are away from their computer
for a team or group organiser, where personal status can be disseminated easily and non-intrusively to many people
as a business tool similar to out-of-office, but which can be checked by anyone non-intrusively on demand rather than just when a communication attempt fails
the publication of a text enquiry number for a utility company, where status enquires can be made conveniently by customers using a text message when utility problems occur, without requiring live agents to answer voice calls.

Many other functions or services are possible according to the present invention, which is not limited to the provision of status messages on demand. The invention can be used to trigger many types of functions in the home network of the B-Party, and can allow the B-Party, if desired, to have control over these functions. The functions are exercised by a characteristic of the originated message sent by an originator on any network. The characteristic could for example be a particular character or character sequence at the start of the message.

In a preferred embodiment, an additional criterion may be used to influence the action of a function performed by the B-Party network in response to receipt of a message that meets a first criterion as described above. Examples of additional criteria that may be used include but are not limited to—
time of day
location of B-Party
current speed of B-Party
A-Party presence on a B-Party-specific whitelist

Such additional criteria could be used in the example personal status service described above to only include location information in a personal status message sent back to whitelisted A parties, while other A parties receive a personal status message without location information. Many other possibilities exist within the envisaged scope of the invention.

In an embodiment of a function that returned a text message to an A-Party, as in the personal status enquiry example given above, it would be possible to include network-specific text, sponsored text or advertisement text in the returned text message.

In an embodiment of the invention, personal status enquiry messages sent to an alphanumeric destination address (alphanumeric in this context is defined in 3GPP specification TS23.038), for example sending a ‘.’ character to the alphanumeric address HERTZ, could return a sponsored message from the Hertz company containing current offers, if Hertz has subscribed to the scheme.

In an embodiment, an A-Party could send one of a number of different status enquiry strings to a B-Party's number, and the B-Party could configure multiple personal status messages each of which could be retrievable by a different A-Party status enquiry message. For example, a coach who managed a rugby and a hockey to team, could set up a separate personal status message for each, and these could be requested respectively by an enquiry message ‘.rugby’ or ‘.hockey’ sent to the coach's number.

It will be appreciated embodiments of the present invention are not limited to personal status enquiries, but provides a means of implementing a desired function (service function) to be selectively carried out by a B-Party network dependent on a characteristic in the message body of a message addressed to the B-Party.

An alternative example of a service function that could be implemented using an embodiment of the present invention is illustrated by the following scenario. An A-Party sends a particular message with predefined syntax (e.g., a single dot character) to a B-Party. The A-Party is present on a whitelist that has been set up by the B-Party. In this case, the function implemented by the system in accordance with an embodiment of the invention is to send a message to the B-Party giving the location of the A-Party. Optionally this example could be further extended to also send the B-Party's location back to the A-Party, so that two messages are generated in response to the single A-Party message. Many other functions are possible and envisaged as falling within the scope of the present invention.

Furthermore, while the network elements in FIG. 1 are schematically shown as comprising various functional blocks, some of which are conventional network elements. It will be appreciated that these elements are shown separately largely for ease of explanation, and in a practical implementation of an embodiment of the invention, the above-described functionality of various ones of these elements may be provided by physically separate network elements, or by a single network element providing the functionality of multiple ones of the functional blocks shown in Figure. Generally, the above-described functionality may be provided by one or more suitably programmed general purpose computers, or by application specific apparatus, as is generally conventional in telecommunications networks.

It will further be appreciated that the terms used herein in connection with text message formats at various stages of routing, e.g., terms such as “mobile originated/originating” (MO) and “mobile terminated/terminating” (MT) are used in the context of their well understood meanings as defined in the relevant telecommunication network standards, e.g., the TS 23.040 standard (see www.3gpp.org/ftp/Specs/1999-10/for-itu/23040-320.pdf) and later versions thereof. Thus, for example, an MO message is a message originating from a sender (e.g., from a sender's telephone handset or from a host computer, e.g., for bulk or automated sending of text messages) in accordance with the well understood Mobile Application Protocol (MAP) and which has not previously passed through an SMSC (or equivalent network element, such as an SMS Router). An MT message, on the other hand, is a message that has been converted from an MO message by an SMSC (or equivalent network element, such as an SMS Router, that is to say equivalent in the sense of also converting a message from MO to MT format) to an MT format for onward delivery to the recipient. An HO format message (host originated) is conventionally understood to mean a message from an external host equipment arriving at an SMSC via a host interface, typically over a non-MAP interface, such as SMPP/IP.

In so far as the embodiments of the invention described above may be implemented, at least in part, using software controlled processing apparatus, it will be appreciated that a computer program providing such software control and a storage medium by which such a computer program is stored are envisaged as aspects of the invention.

Thus a method for providing a service function in a telecommunications network is described. The method comprises receiving a message addressed to an addressee subscriber of the telecommunications network. The received message may be an MMS message or an SMS message in a mobile terminated (MT) format and/or may come from a subscriber of a different network. The method further comprises determining whether the body of the received message conforms to a predefined criterion, and, if so, selectively providing the service function. In one example the predefined criterion is a specific syntax for the body of the received message. The processing function may comprise sending a response message to the sender of the received message providing information previously specified by the addressee subscriber. Thus a sending user can obtain the information previously specified by the addressee subscriber by simply sending him a message conforming to the predefined criterion. The received message might not be forwarded on to the addressee subscriber so that he is not disturbed when messages are received to request the relevant information.

Thus in accordance with some embodiments there is provided a method for providing a service function in a telecommunications network, the method comprising: receiving a text message addressed to an addressee subscriber of the telecommunications network in a mobile terminated (MT) format; determining whether the body of the received text message conforms to a predefined criterion; and selectively providing the service function dependent upon whether or not the body of the received text message is determined to conform to the predefined criterion.

Furthermore, in accordance with some embodiments of the invention there is provided a method for providing a service function in a telecommunications network, the method comprising: receiving a text message addressed to an addressee subscriber of the telecommunications network originating from a subscriber of a different telecommunications network (for example with the message in a mobile terminated (MT) format or host originated (HO) format—i.e. in a format other than a mobile originated (MO) format); determining whether the body of the text message conforms to a predefined criterion; and selectively providing the service function dependent upon whether or not the body of the text message is determined to conform to the predefined criterion.

According to some embodiments of the invention there is provided a system for providing a service function in a telecommunications network, the system comprising: a text message receiving unit operable to receive a text message addressed to an addressee subscriber of the telecommunications network in a mobile terminated (MT) format; a determination unit operable to determine whether the body of the received text message conforms to a predefined criterion; and a function providing unit operable to selectively provide the service function dependent upon whether or not the body of the received text message conforms to the predefined criterion.

According to some embodiments of the invention there is provided a system for providing a service function in a telecommunications network, the system comprising: a text message receiving unit operable to receive a text message addressed to an addressee subscriber of the telecommunications network and originating from a subscriber of a different telecommunications network; a determination unit operable to determine whether the body of the received text message conforms to a predefined criterion; and a function providing unit operable to selectively provide the service function dependent upon whether or not the body of the received text message conforms to the predefined criterion.

Further particular and preferred aspects of the present invention are set out in the accompanying independent and dependent claims. It will be appreciated that features of the dependent claims may be combined with features of the independent claims as appropriate, and in combinations other than those explicitly set out in the claims.

It will be appreciated from the foregoing description that embodiments of the invention provide a means for an addressee subscriber to publish any information that he desires, and hence that the invention provides a vehicle for instant publishing. That is to say, the service function provided in accordance with embodiments of the invention may be the provision of information in response to a received message from a third party in effect requesting the information, e.g. because the received message conforms to a predefined criterion. The published information can, for example, be set up by the addressee subscriber (who may also be referred to as the publisher) using the configuration message techniques described above, and anyone who sends a suitably formatted message (e.g. a single dot character in a preferred embodiment) to the addressee subscriber will then receive a message in return containing the published information. Unlike other popular media such as facebook or Twitter that have a reach limited to their own registered subscribers, embodiments of the present invention can in principle reach to every mobile telephone in the world (today about 5 billion) without any need for registration on the part of a mobile telephone user who sends a suitably formatted message in order to receive the published information. Thus in accordance with embodiments of the invention any mobile telephone user on any network can receive published information from an addressee subscriber, merely by sending a suitably formatted message to the normal telephone number of the addressee subscriber. This represents unprecedented connectivity between publishers (i.e. addressee subscribers) and users who may wish to receive the published information.

It will also be appreciated that while the foregoing description has primarily focused on embodiments of the invention in the context of SMS and text messages, other embodiments of the invention may not be not limited to using SMS and text messages but may encompasses other media. For example, in some embodiments it may be advantageous to support the publishing of information using Multimedia Messaging (MMS). MMS is an established technology defined in the various relevant mobile telephony standards, that can support components comprising text, video, images and audio in any combination, subject to constraints of overall message size. It would be possible for such media components to be configured either together or separately by a publisher (as noted above, the term publisher is used here to refer to an addressee subscriber using an embodiment of the invention to make information widely available). For example, a publisher could send an MMS configuration message to define his published information, and in this case the multimedia content of the configuration message could form all or part of the published information in broadly the same was as described above for an SMS configuration message. (As with the text examples described above, additional information could be automatically added by the network.) Alternatively, the system could be set up so that individual media components of the desired multimedia published information could be configured separately. In this case, the components of the multimedia published information could be combined dynamically into an MMS message whenever a suitably formatted message (e.g. a message conforming to at least one predefined criterion) is sent to the publisher (i.e. the addressee subscriber). An advantage of this technique is that it gives the publisher the flexibility to update each component of his multimedia published information separately as desired. Preferably the text component could be updated by SMS, and the audio component could be updated by a voice call. For example, a traveler could periodically update his current published information by configuring a new picture, sending new text using SMS or MMS, or by recording a new piece of audio. Users sending a suitably formatted message may then receive a composite MMS message comprising the latest components combined into a single MMS message.

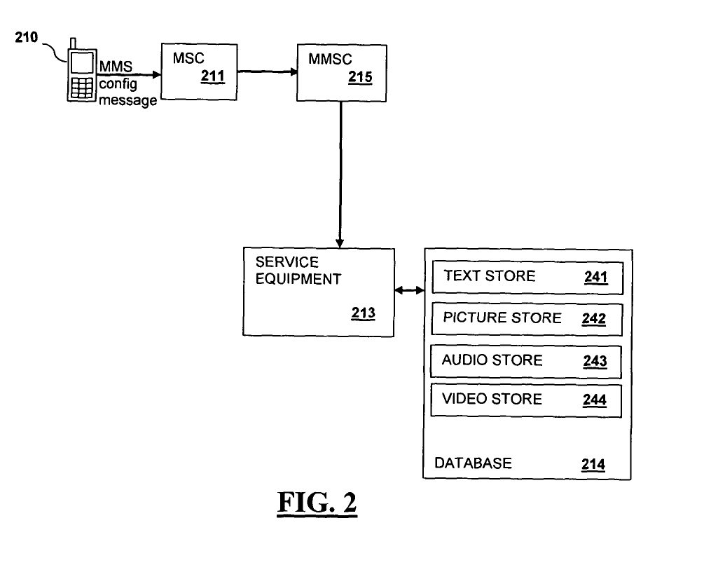

FIG. 2 schematically shows one example of configuration of published information by a publisher 210 using MMS. Various aspects of FIG. 2 are similar to and will be understood from corresponding elements of FIG. 1 and their associated description provided in the context of SMS configuration. Also, it will be appreciated that various conventional aspects of the network of FIG. 2 are not shown here in the interest of simplicity. The MMS configuration message passes via the MSC 211 and MMSC 215 in the publisher's network and is directed to service equipment 213, which could be implemented as part of the MMSC 215 or separately. Depending on the multimedia component(s) supplied in the MMS configuration message, the respective stores for text 241, picture 242. audio 243 and video 244 content are set or updated in a database 214 coupled to the service equipment 213. Alternatively and/or optionally, a text component could be updated by SMS, and an audio component could be updated by a voice call.

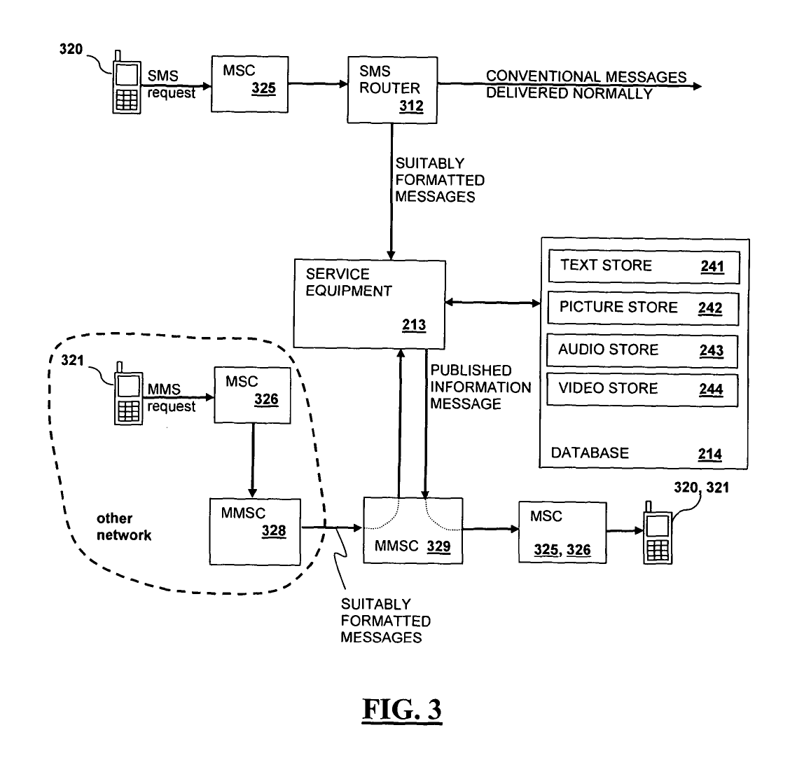

FIG. 3 shows how user requests for MMS published information might be handled in accordance with an embodiment of the invention, e.g. in the network represented in FIG. 2. This may be performed in two ways in this example: by SMS from a user 320 on the same network as the publisher, and by MMS from a user 321 on a different network from the publisher. It will be appreciated that other permutations are possible.

In accordance with this example, the user 320 sends a suitably formatted message (i.e. a message conforming to at least one predefined criterion) by SMS via an MSC 325 and an SMS Router 312. The SMS router is configured so that suitably formatted messages are directed by the SMS Router to the service equipment 213, while other (conventional) messages are delivered normally. The user 21, on the other hand, sends a suitably formatted MMS message (i.e. an MMS message conforming to at least one predefined criterion) which passes via his own network's MSC 326 and MMSC 328 and the addressee subscriber's MMSC 329 where it is directed to the service equipment 213. Other MMS messages that are not suitably formatted are delivered normally (this routing is not shown in FIG. 2).

Thus an information request may be made in the form of a suitably formatted SMS from user 320 or a suitably formatted MMS from user 321. The published information may then be constructed from/in dependence on the information stored in the database 214, and delivered as an MMS message via the MMSC 29 to the relevant user 20, 21 (i.e. user 20 for the SMS request case and user 21 for the MMS request case) via their respective MSCs 325, 326. In this way by the use of MMS, a richer publishing medium is made available to the publisher without necessarily increasing the complexity of every publishing operation, since the publisher may choose to simply update the text component of his current published information with a text message such as described above.

A significant feature of some embodiments of the present invention is that a suitably formatted message sent from a user to a publisher is preferably not delivered to the publisher. In this way, published information can be retrieved from a publisher without disturbing him. This might be particularly important for example in the case of a celebrity who was publishing information. At peak times it may be that many hundreds or thousands of requests could be addressed to the celebrity's number in a short period of time, and it would be undesirable to attempt to deliver all of these messages to the celebrity's telephone. Other messages that are not suitably formatted are not intercepted and are delivered normally, e.g. as described above.

In some embodiments, it would be possible to use a different request syntax for example in order to request delivery of published information by text or by MMS. In a preferred embodiment, a single dot could be used to request published information to be returned by text message, while two dots could be used to request published information to be returned by MMS. The request message itself could be sent using either SMS or MMS.

In some embodiments, additional text after the dot (or 2 dots) could be used to narrow a user request, for example for selecting between different categories of published information. For example, the coach of both a rugby and a hockey team could be provided with the capability to return different published information in response to requests conforming to different criteria, such as containing the text string “.rugby” or “.hockey”.

It will be appreciated that the services that can be offered by embodiments of the present invention are applicable to the addressee subscriber's (publisher's) network. The addressee subscriber's network is responsible for detecting specific syntax in a message sent by a user to an addressee subscriber, and on detection of this syntax the addressee subscriber's network can invoke whatever service is required. Embodiments of the invention have been illustrated by the use of a publishing service example, though the invention is by no means restricted to this application. In order for the addressee subscriber's network to be able to detect the specific syntax in a received message, it is helpful for all such received messages to pass through a processing platform associated with the addressee subscriber's network. As previously described this may be achieved for SMS request messages in a GSM network by means of SMS Home Routing. For MMS request messages, these already pass through an MMSC in the addressee subscriber's network, and so detection of request messages may be done either in the MMSC or in an adjunct processor in the MMS path. For US and other networks that use aggregators for passing messages between networks, the detection may be done in the HO or MT paths as previously described.

Using similar techniques, it is also possible to apply the principles of the present invention to fixed networks. Many fixed telephone networks today support SMS messaging, i.e. fixed-line numbers can receive SMS. It is therefore possible for the suitably formatted messages of the present invention to be directed to fixed-line numbers. The requirement to direct all such messages through a node or nodes in the receiving network for detection purposes is also satisfied, since all such fixed-line SMS messages are already directed to equipments in the addressee's network where they are converted to a format suitable for fixed-line delivery. Request message detection may therefore be done by these equipments, or by an adjunct processor in the received message path.

It will be apparent from the above that a significant advantage of some embodiments of the present invention is the ease with which a user can obtain published information from a publisher who is in the user's address book.

### REFERENCES

[1] EP 1 474 934 (Intellprop Limited)
[2] EP 1 408 705 (Telsis Holdings Limited)
[3] EP 1 815 697 (Intellprop Limited)

1. A method for providing a service function in a telecommunications network, the method comprising:
receiving in the telecommunications network a message addressed to an addressee subscriber of the telecommunications network, wherein the message is a Short Message Service (SMS) message in a mobile terminated (MT) format or a Multimedia Messaging Service (MMS) message;
determining whether the body of the received message conforms to a predefined criterion; and
selectively providing the service function dependent upon whether or not the body of the received message conforms to the predefined criterion.

2. A method for providing a service function in a telecommunications network, the method comprising:
receiving in the telecommunications network a message addressed to an addressee subscriber of the telecommunications network originating from a subscriber of a different telecommunications network, wherein the message is a Short Message Service (SMS) message or a Multimedia Messaging Service (MMS) message;
determining whether the body of the message conforms to a predefined criterion; and
selectively providing the service function dependent upon whether or not the body of the message conforms to the predefined criterion.

3. A method according to claim 1, wherein providing the service function comprises sending a response message to the originator of the received message.

4. A method according to claim 3, wherein the response message includes information content specified by the addressee subscriber for use in conjunction with the service function.

5. A method according to claim 4, wherein the information content is specified by the addressee subscriber in at least one configuration message previously sent to the telecommunications network.

6. A method according to claim 5, wherein the information content comprises a number of components and wherein different ones of the components are specified by the addressee subscriber in different configuration messages.

7. A method according to claim 3, wherein the response message includes information content automatically generated by the network.

8. A method according to claim 3, wherein the response message includes information content specifying status information for the addressee subscriber.

9. A method according to claim 3, wherein the response message includes information content which the addressee subscriber wishes to disseminate.

10. A method according to claim 1, wherein providing the service function comprises inhibiting forwarding of the received message to the addressee subscriber.

11. A method according to claim 1, wherein the body of the message conforms to the predefined criterion if the body of the message corresponds to a predefined syntax.

12. A method according to claim 1, wherein the provision of the service function is further dependent on the identity of the originator of the received message.

13. A method according to claim 1, further comprising selectively providing the service function dependent upon at least one further criterion being met.

14. A system for providing a service function in a telecommunications network, the system comprising:
a message receiving unit operable to receive in the telecommunications network a message addressed to an addressee subscriber of the telecommunications network, wherein the message is a Short Message Service (SMS) message in a mobile terminated (MT) format or a Multimedia Messaging Service (MMS) message;
a determination unit operable to determine whether the body of the received message conforms to a predefined criterion; and
a function providing unit operable to selectively provide the service function dependent upon whether or not the body of the received message conforms to the predefined criterion.

15. A system for providing a service function in a telecommunications network, the system comprising:
a message receiving unit operable to receive in the telecommunications network a message addressed to an addressee subscriber of the telecommunications network and originating from a subscriber of a different telecommunications network, wherein the message is a Short Message Service (SMS) message or a Multimedia Messaging Service (MMS) message;
a determination unit operable to determine whether the body of the received message conforms to a predefined criterion; and
a function providing unit operable to selectively provide the service function dependent upon whether or not the body of the received message conforms to the predefined criterion.
